(19) United States
(12) Patent Application Publication
(10) Pub. No.: US 2006/0284542 A1
(43) Pub. Date: Dec. 21, 2006

(54) Cathode ray tube

(75) Inventors: Masaki Kawasaki, Toyonaka-shi (JP); Hiroyuki Yamashita, Osaka-shi (JP); Masahide Yamauchi, Kyoto-shi (JP); Hideo Iguchi, Osaka-shi (JP); Masaharu Kawano, Takatsuki-shi (JP); Akemi Kawamoto, Ibaraki-shi (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-shi (JP)

(21) Appl. No.: 11/415,295

(22) Filed: May 1, 2006

(30) Foreign Application Priority Data
Jun. 17, 2005 (JP) 2005-178137

(51) Int. Cl. H01J 29/86; H01J 29/92; H01J 29/88; H01J 29/87

(52) U.S. Cl. 313/477 R; 313/479; 220/2.1 R; 220/2.1 A

(57) ABSTRACT

When the thickness of the panel at an X axis end of the useful portion is expressed by Tx (mm), the thickness thereof at a Y axis end is expressed by Ty (mm), the thickness thereof at the center is expressed by Tc (mm) and an outer dimension of the panel along the diagonal axis direction is expressed by D (mm), 0.8≦(100×Tc/D)²×(Tx/Ty)≦2.2 and 0.012≦Tc/D≦0.019 are satisfied. Accordingly, the stress generated in a short side and that generated in a long side in a sealing portion in an exhausting process are substantially equalized. As a result, cracking of the panel can be reduced in the exhausting process even when the panel is made thinner. Therefore, it is possible to provide a cathode ray tube that is easy to manufacture and has a lighter and less expensive panel.

### BACKGROUND OF THE INVENTION

1. Field of the Invention

The present invention relates to a cathode ray tube.

2. Description of Related Art

As shown in FIG. 9, a cathode ray tube 1 used in a television receiver or the like includes an envelope 10 constituted by a glass panel 3 whose inner surface is provided with a phosphor 2 or the like and a glass funnel 5 whose inner surface is provided with an electrically conductive film 4 or the like that are sealed with a frit glass 8. An electron beam emitted from an electron gun 6 disposed in a neck portion 5a of the funnel 5 strikes the phosphor 2 so as to emit light, thereby displaying an image.

A process of manufacturing such a cathode ray tube 1 includes a sealing process of passing the panel 3 and the funnel 5 through a furnace at about 450° C. for sealing them with the frit glass 8 and an exhausting process of passing the cathode ray tube 1 through a furnace at about 350° C. for exhausting the cathode ray tube 1. Especially in the exhausting process, the envelope 10 is subjected not only to a thermal stress but also to an outside air pressure when creating a high vacuum inside the envelope 10. Thus, especially in the envelope 10 for middle and large sized tubes such as at least about 51-cm-diagonal tubes, the vicinity of the frit glass 8 (namely, a sealing portion) is likely to be cracked, so that the manufacturing is not easy. This problem is more serious for the envelope using the panel 3 whose useful portion has a substantially flat outer surface, which has become widespread recently.

Conventionally, in order to deal with this problem, it has been suggested to employ a method of performing the exhausting process at a temperature not higher than a softening point of a plastic reinforcer 7 while the reinforcer 7 is made to adhere and fixed to an outer surface of the envelope as shown in FIG. 10 (see JP 8(1996)-7793 A) and a method of extending a skirt portion on the periphery of the panel 3 along a tube axis direction (see JP 3(1991)-236142 A), for example.

However, the former method has the following problem. That is, the plastic reinforcer 7 that withstands a high temperature is expensive. Also, when the exhausting process is carried out at a low temperature, it takes a very long time to achieve the necessary degree of vacuum. Further, a resin, etc. used in a process of forming the phosphor 2 remains without burning in the exhausting process, which may generate a gas later, resulting in a lowered degree of vacuum. Thus, an excellent cathode ray tube cannot be manufactured.

On the other hand, the latter method has the following problem. That is, an increase in the weight of the panel 3 raises the price of the panel 3. Also, in the sealing process, it takes very long to heat the panel 3 until a temperature distribution becomes uniform.

### SUMMARY OF THE INVENTION

It is an object of the present invention to solve the conventional problems described above and to provide a cathode ray tube that includes a panel having a substantially flat useful portion, is easy to manufacture and allows the reduction of the weight and cost of the panel.

A cathode ray tube according to the present invention includes an envelope formed by connecting a glass funnel and a glass panel having a substantially rectangular useful portion whose outer surface is substantially flat.

The cathode ray tube satisfies
0.8≦(100×Tc/D)²×(Tx/Ty)≦2.2, and (1)
0.012≦Tc/D≦0.019 (2)
where a Z axis indicates a tube axis, an X axis indicates an axis that is perpendicular to the Z axis and parallel with a long-side direction of the useful portion, a Y axis indicates an axis that is perpendicular to the Z axis and parallel with a short-side direction of the useful portion, TX (mm) represents a thickness of the panel at a point of intersection of a plane including the X axis and the Z axis and an edge of the useful portion, Ty (mm) represents a thickness of the panel at a point of intersection of a plane including the Y axis and the Z axis and an edge of the useful portion, Tc (mm) represents a thickness of the panel at a center of the useful portion, and D (mm) represents an outer dimension of the panel along a diagonal axis direction.

### BRIEF DESCRIPTION OF THE DRAWINGS

FIG. 1 is a perspective view showing a panel for a cathode ray tube according to a working example of the present invention when viewed from a front side.

FIG. 2 is a perspective view showing the panel for the cathode ray tube according to a working example of the present invention when viewed from a back side.

FIG. 3 is a sectional view showing the panel for the cathode ray tube according to a working example of the present invention taken along an XZ plane.

FIG. 4 is a sectional view showing the panel for the cathode ray tube according to a working example of the present invention taken along a YZ plane.

FIG. 5 is a graph showing an effect of the present invention.

FIG. 6 is a perspective view showing an external appearance of a cathode ray tube according to an embodiment of the present invention.

FIG. 7 is a perspective view showing an external appearance of a cathode ray tube according to another embodiment of the present invention.

FIG. 8 is a perspective view showing an external appearance of a cathode ray tube according to yet another embodiment of the present invention.

FIG. 9 is a sectional view showing a general cathode ray tube.

FIG. 10 is a sectional view showing a method for manufacturing a conventional cathode ray tube for improving a mechanical strength with respect to an outside air pressure.

### DETAILED DESCRIPTION OF THE INVENTION

Conventionally, since a larger stress has been generated in a long side than in a short side in the sealing portion of the panel in the exhausting process, the long side has been likely to be cracked. In contrast, the panel according to the present invention satisfies Formulae (1) and (2), whereby the stress generated in the short side and that generated in the long side in the sealing portion in the exhausting process are substantially equalized. As a result, the stress generated in the long side lowers, so that it is possible to withstand the stress in the exhausting process sufficiently even when the panel is made thinner than a conventional panel. In other words, it is possible to achieve a cathode ray tube that has a thin panel, is not cracked easily and is easy to manufacture.

Further, the reduction of the panel thickness achieves a lighter panel and a lower material cost. Moreover, it becomes possible to shorten the time for the exhausting process and reduce the amount of heat to be supplied. In the sealing process, it also becomes possible to shorten the time necessary for heating the panel uniformly and reduce the amount of heat to be supplied. Consequently, the productivity improves, thereby lowering the cost of the cathode ray tube.

It is preferable that the above-described cathode ray tube according to the present invention further includes a metal band placed on an outer peripheral surface of a skirt portion of the panel, and a resin sheet attached so as to cover at least the outer surface of the useful portion, and the cathode ray tube satisfies
0.012≦Tc/D≦0.016. (3)

This prevents glass pieces of the panel from being scattered forward beyond the panel even if the envelope of the cathode ray tube implodes. As a result, strict safety standards such as the Electrical Appliance and Material Control Law, UL (Underwriters' Laboratories Inc.) standards and CSA (Canadian Standards Association) standards can be satisfied fully. Furthermore, the panel does not have to be made thicker for satisfying these safety standards. Thus, it becomes possible to reduce the weight and cost of the panel considerably while maintaining a sufficient safety level. Moreover, the considerable reduction of the panel weight makes it possible to shorten a heating time and reduce the amount of heat to be supplied considerably in a sealing process and an exhausting process, thus achieving a still lower cost.

It is preferable that the resin sheet has a thickness of equal to or larger than 50 μm. This makes it possible to satisfy fully the various safety standards.

It also is preferable that the resin sheet has a thickness of equal to or larger than 25 μm, and the resin sheet is attached to the panel in such a manner as to extend from the useful portion to at least a part of a portion of the metal band parallel with the X axis. Alternatively, it is preferable that the resin sheet has a thickness of equal to or larger than 25 μm, and the resin sheet is attached to the panel in such a manner as to extend from the useful portion to at least a part of a portion of the metal band parallel with the Y axis. In these cases, the various safety standards can be satisfied fully.

It is preferable that the useful portion has a dimension along its diagonal axis of at least about 41 cm. When the present invention is applied to such middle and large sized cathode ray tubes that have a heavy panel and tend to be produced at a high cost, the effects of the present invention become clearly apparent.

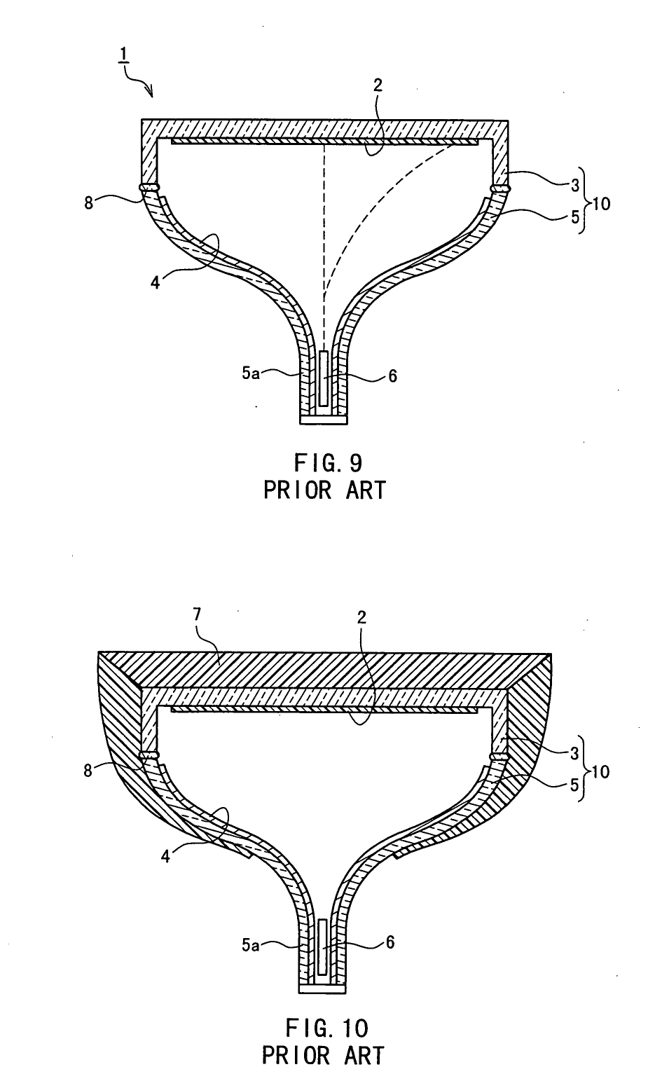

The cathode ray tube according to the present invention is not particularly limited except for the structure of a glass panel and its vicinity described in the following and may be similar to the conventional cathode ray tube illustrated in FIG. 9, for example. Thus, the repetitive descriptions will be omitted, and a characteristic structure of the present invention will be described in the following.

The present invention will be described by taking a cathode ray tube whose useful portion has a dimension along its diagonal axis of 51 cm as an example (hereinafter, referred to as a “working example”).

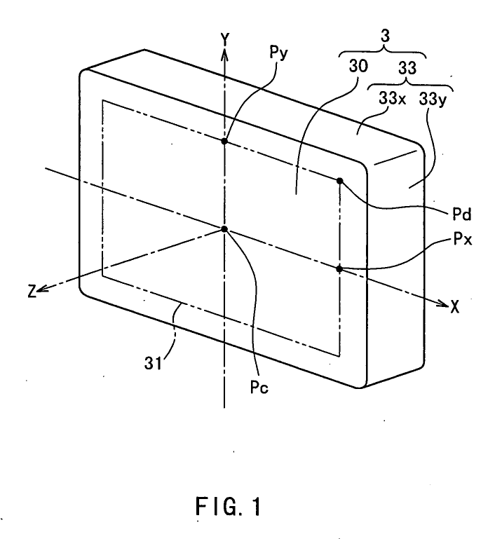

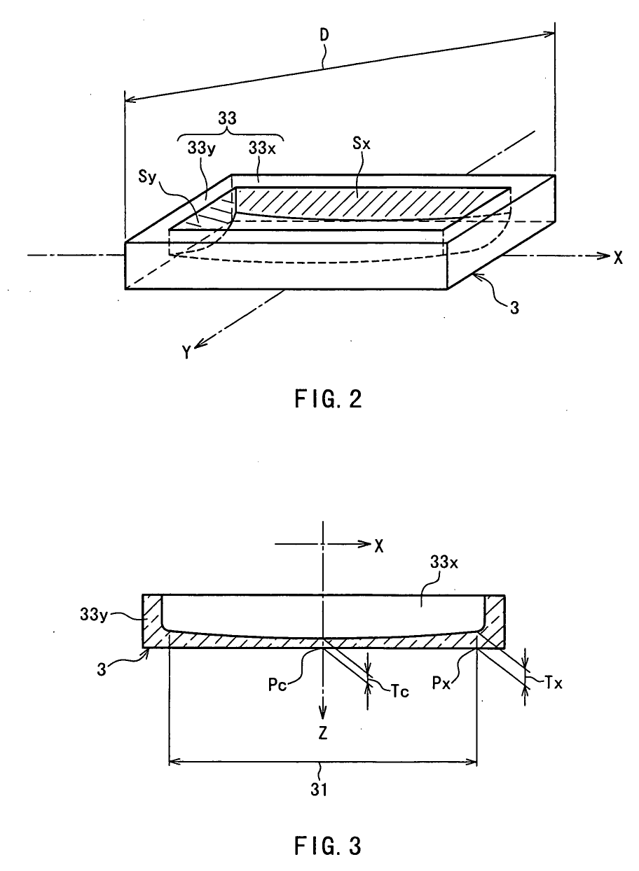

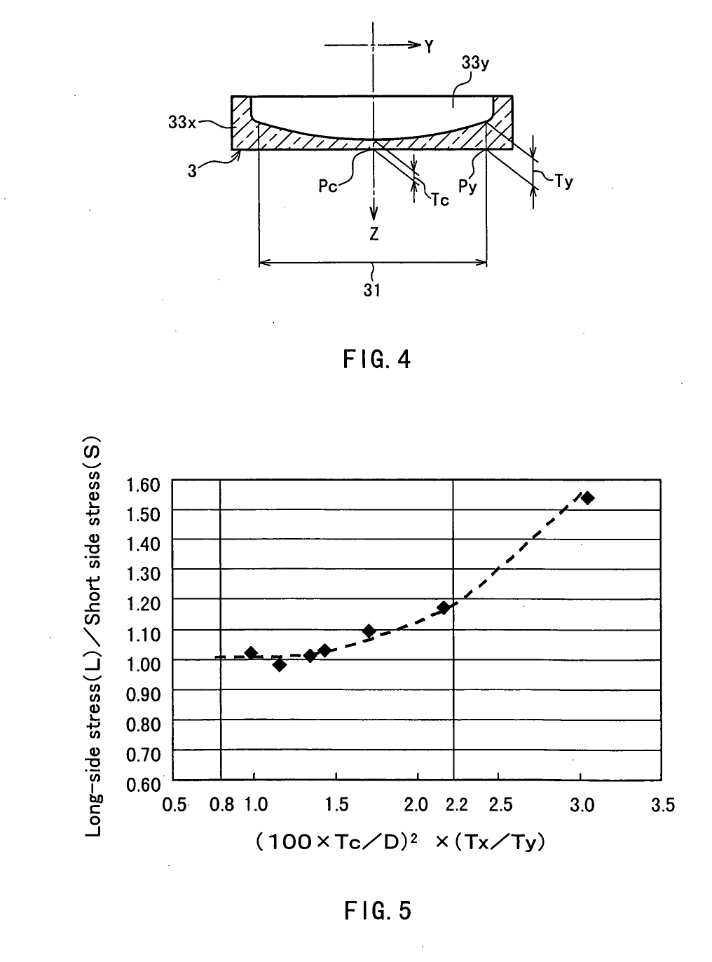

FIG. 1 is a perspective view showing a panel 3 for the cathode ray tube according to the present working example when viewed from a front side. FIG. 2 is a perspective view showing the panel 3 that is placed with its surface provided with a phosphor 2 (see FIG. 9) facing upward. The glass panel 3 includes a faceplate 30 having a substantially rectangular useful portion 31, and a skirt portion 33 provided on the periphery of the faceplate 30 so as to be bent from the faceplate 30. For convenience of description in the following, a Z axis indicates a tube axis of the cathode ray tube, an X axis indicates an axis that is perpendicular to the Z axis and parallel with a long-side direction of the useful portion 31, and a Y axis indicates an axis that is perpendicular to the Z axis and parallel with a short-side direction of the useful portion 31. FIG. 3 is a sectional view showing the panel 3 taken along a plane including the X axis and the Z axis (an XZ plane), and FIG. 4 is a sectional view showing the panel 3 taken along a plane including the Y axis and the Z axis (a YZ plane).

The “useful portion 31” in the present invention refers to a region provided with the phosphor 2 on the inner surface of the panel 3 or a region on the outer surface of the panel 3 corresponding to that region. The outer surface of the useful portion 31 is substantially flat. More specifically, when a point through which the Z axis passes in the useful portion 31 is expressed by a center Pc and points of intersection of a plane including a diagonal axis of the useful portion 31 and the Z axis and edges of the useful portion 31 are expressed by diagonal axis ends Pd, it is preferable that a radius of curvature of a circular arc defined by two diagonal axis ends Pd aligned along a diagonal axis direction and the center Pc is equal to or larger than 8,000 mm. The substantially flat outer surface of the useful portion 31 improves the visibility of a displayed image. For simplification, the outer surface of the faceplate 30 including the useful portion 31 is shown to be flat in FIGS. 1 to 4.

Now, the thickness of the panel 3 along the Z-axis direction at a point of intersection of the XZ plane and an edge of the useful portion 31 (hereinafter, referred to as an “X axis end”) Px is expressed by Tx (mm). The thickness of the panel 3 along the Z-axis direction at a point of intersection of the YZ plane and an edge of the useful portion 31 (hereinafter, referred to as a “Y axis end”) Py is expressed by T (mm). The thickness of the panel 3 along the Z-axis direction at the center Pc of the useful portion 31 is expressed by Tc (mm). The thickness of the panel 3 along the Z-axis direction at the diagonal axis end Pd is expressed by Td (mm). Further, an outer dimension of the panel 3 along the diagonal axis direction is expressed by D (mm). The analysis was made of the relationship between the dimension of these individual portions of the panel 3 and the stress generated in the sealing portion of the panel 3 and the funnel 5 in the exhausting process, which was one process in the process for manufacturing the cathode ray tube.

In the exhausting process, the sealing portion of the panel 3 is subjected to a combined stress of the stress caused by an outside air pressure and the thermal stress. In general, as the panel 3 becomes thinner, the stress caused by the outside air pressure increases and the thermal stress decreases.

When the areas of inner wall surfaces of a part of the skirt portion 33 parallel with the X axis (a long side skirt portion 33x) and a part thereof parallel with the Y axis (a short side skirt portion 33y) are expressed respectively by Sx and Sy as shown in FIG. 2, a conventional general panel satisfies Sx>Sy. Thus, a total load caused by the outside air pressure is larger in the long-side skirt portion 33x than in the short-side skirt portion 33y. Accordingly, the maximum value of the stress in the sealing portion generated by the outside air pressure is present not on the side of the short-side skirt portion 33y but on the side of the long-side skirt portion 33x. As a result, in the exhausting process, the sealing portion is more likely to be cracked on the side of the long-side skirt portion 33x than on the side of the short-side skirt portion 33y.

Thus, in the present invention, the ratio Tx/Ty of the thickness Tx of the panel 3 at the X axis end Px to the thickness Ty of the panel 3 at the Y axis end Py is made smaller, thereby reducing the difference between the area Sx and the area Sy. In this way, the stress generated in the sealing portion on the side of the long-side skirt portion 33x and that on the side of the short-side skirt portion 33y can be substantially equalized. In other words, the stress generated in the sealing portion on the side of the long-side skirt portion 33x can be alleviated. Furthermore, since the maximum value of the stress generated in the sealing portion decreases, it becomes possible to reduce the thickness of the panel 3. This allows the reduction of the weight and cost of the panel 3. Also, by reducing the thickness of the panel 3, the thermal stress in the exhausting process can be lowered, so that the sealing portion becomes even less likely to be cracked.

Table 1 shows results of analyzing the maximum stress acting on the sealing portion during the exhausting process with respect to various dimensions of the individual portions of the panel 3. In Table 1, “Conventional product” indicates a conventional representative panel. “Long side L” indicates the maximum value of the stress acting on the sealing portion on the side of the long-side skirt portion 33x during the exhausting process, “Short side S” indicates the maximum value of the stress acting on the sealing portion on the side of the short-side skirt portion 33y during the exhausting process, and both of them are shown as a relative value. “L/S” means the ratio of “Long side L” to “Short side S”. Further, “Weight ratio” indicates a relative value of the weight of the panel 3 with respect to that of the “Conventional product”. FIG. 5 shows the relationship between a parameter “(100×Tc/D)²×(Tx/Ty)” in Table 1 and the ratio “L/S”.

TABLE 1

| | | | | | | | | | Stress in | | | |
|---|---|---|---|---|---|---|---|---|---|---|---|---|
| | | | | | | | | | sealing | | | |
| | | | | | | | | (100 × | portion | | | |
| | Tc | Tx | Ty | Td | D | Ty/ | | Tc/D)² × | Long | Short | | Weight |
| Sample | (mm) | (mm) | (mm) | (mm) | (mm) | Tx | Tc/D | (Tx/Ty) | side L | side S | L/S | ratio |
| *Cp | 11.5 | 14.3 | 20.9 | 21.4 | 544.9 | 1.46 | 0.0211 | 3.05 | 1.00 | 0.65 | 1.54 | 1.00 |
| T-1 | 10 | 12.5 | 19.4 | 19.9 | 544.9 | 1.55 | 0.0184 | 2.17 | 0.96 | 0.82 | 1.17 | 0.93 |
| T-2 | 9 | 11.5 | 18.4 | 18.9 | 544.9 | 1.60 | 0.0165 | 1.71 | 0.95 | 0.87 | 1.09 | 0.88 |
| T-3 | 8.5 | 9.4 | 16.0 | 16.5 | 544.9 | 1.70 | 0.0156 | 1.43 | 0.94 | 0.92 | 1.03 | 0.83 |
| T-4 | 8 | 10.8 | 17.4 | 17.9 | 544.9 | 1.61 | 0.0147 | 1.34 | 0.95 | 0.94 | 1.01 | 0.84 |
| T-5 | 7.5 | 10.3 | 16.9 | 17.4 | 544.9 | 1.64 | 0.0138 | 1.15 | 0.97 | 0.99 | 0.98 | 0.81 |
| T-6 | 7 | 9.8 | 16.4 | 16.9 | 544.9 | 1.67 | 0.0128 | 0.99 | 0.98 | 0.96 | 1.02 | 0.79 |

*Cp: Conventional product

From Table 1 and FIG. 5, in the case where
0.8≦(100×Tc/D)²×(Tx/Ty)≦2.2, and (1)
0.012≦Tc/D≦0.019 (2)
are satisfied (Samples T-1 to T-6), the stress L on the side of the long-side skirt portion 33x and the stress S on the side of the short-side skirt portion 33y are equalized, and their values are smaller than the stress L on the side of the long-side skirt portion 33x of the “Conventional product”. Thus, it is possible to withstand the stress during the exhausting process sufficiently, so that the likelihood of cracks in the panel 3 can be lowered. When cathode ray tubes of all of Samples T-1 to T-6 shown in Table 1 actually were prototyped, it was confirmed that all of them were manufactured without any cracks under the same manufacturing conditions as “Conventional product”.

Also, in the case where Formulae (1) and (2) above are satisfied, the panel 3 is thinner and lighter than “Conventional product”. Thus, it becomes possible to shorten the time for the exhausting process and reduce the amount of heat to be supplied. Furthermore, in the sealing process, it also becomes possible to shorten the time necessary for heating the panel 3 uniformly and reduce the amount of heat to be supplied.

For example, the thermal stress in the sealing portion of the Sample T-5 in Table 1 during the sealing process was analyzed and found to be about 23% smaller than that of “Conventional product”. When the time for the sealing process actually was shortened by 20% compared with the case of “Conventional product”, it was confirmed that no problem arose for sealing. Moreover, since the panel 3 was about 20% lighter than “Conventional product”, it was possible to reduce the amount of heat to be supplied by about 10% during the exhausting process.

With respect to Sample T-6 in Table 1, the thickness Tc at the center Pc of the useful portion 31 is reduced by about 40% compared with that of “Conventional product”, and the panel 3 is at least 20% lighter than “Conventional product”. Nevertheless, the stress in the sealing portion during the exhausting process is kept smaller than the stress L on the side of the long-side skirt portion 33x of “Conventional product”. Therefore, the panel 3 is not cracked during the exhausting process.

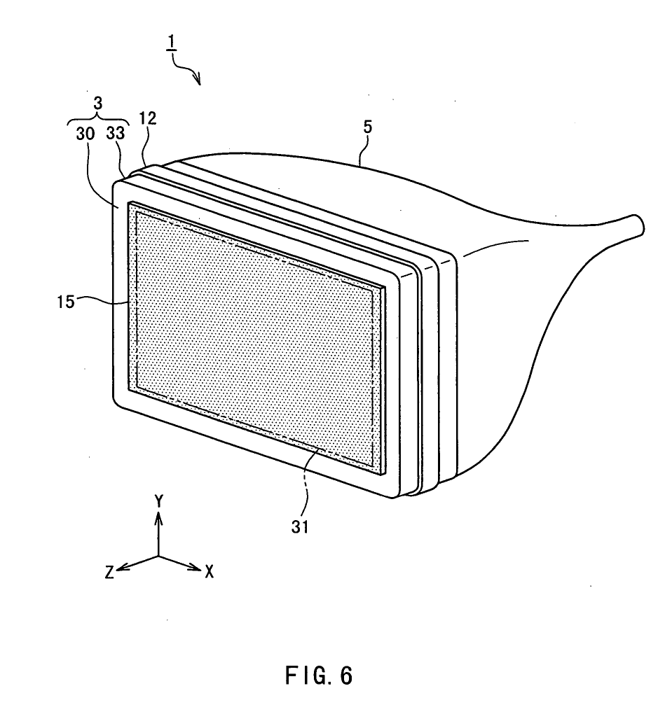

However, in addition to the cracks during the exhausting process, a breakage of the envelope 10 of the cathode ray tube due to an implosion has to be considered. The breakage due to implosion is a phenomenon in which the envelope 10 whose inner space is maintained under vacuum after the exhausting process is broken by the atmospheric pressure when a strong external impact is applied. There are several safety standards specifying that pieces of glass of the panel 3 are not scattered at the time of breakage due to implosion. When the thickness Tc of the useful portion 31 at the center Pc is made smaller as described above, the envelope 10 of the cathode ray tube generally becomes more likely to be broken due to implosion by the atmospheric pressure. In terms of prevention of implosion, a larger ratio Tc/D of the thickness Tc of the useful portion 31 at the center Pc with respect to the dimension D of the panel 3 along the diagonal axis direction is more preferable. By satisfying Tc/D≧0.012, placing a metal band 12 on an outer peripheral surface of the skirt portion 33 of the panel 3 as shown in FIG. 6 and attaching a resin sheet 15 so as to cover at least the outer surface of the useful portion 31 of the panel 3, it is possible to lower the likelihood of implosion and lower the likelihood that the glass pieces are scattered forward beyond the panel 3 even if the implosion occurs. The inventors of the present invention confirmed by experiment that meeting these conditions fully satisfied the safety standards such as the Electrical Appliance and Material Control Law, UL (Underwriters' Laboratories Inc.) standards and CSA (Canadian Standards Association) standards.

As the ratio Tc/D increases, the implosion prevention characteristics generally improve, but the panel 3 becomes heavier. According to the experiment conducted by the inventors of the present invention, it was found that Tc/D>0.016 made it possible to satisfy the various safety standards fully even without attaching the resin sheet 15. Therefore, it is preferable to attach the resin sheet 15 when Tc/D≦0.016.

The metal band 12 is not particularly limited but can be a known band that has been used conventionally for cathode ray tubes in order to prevent an implosion of the envelope 10 due to the atmospheric pressure. The metal band 12 prevents the implosion of the panel 3 by suppressing an outward distortion of the skirt portion 33 caused by the atmospheric pressure acting on the faceplate 30.

Also, the resin sheet 15 is not particularly limited but can be a sheet formed of PET (polyethylene terephthalate) or the like, for example. It is preferable that a pressure-sensitive adhesive is applied to the surface of the resin sheet 15 to be attached to the panel 3. The pressure-sensitive adhesive can be, for example, an acrylic pressure-sensitive adhesive, though there is no particular limitation. The resin sheet 15 also may be a functional film whose surface opposite to the panel 3 is provided with an antireflection layer and/or an antistatic layer.

The thickness of the resin sheet 15 is determined suitably according to an attachment region, a material, a mechanical property, an attachment workability, etc.

For example, in the case where the resin sheet 15 was attached to only inside the region of the faceplate 30 as shown in FIG. 6, it was confirmed that the thickness of the resin sheet 15 equal to or larger than 50 μm fully satisfied the various safety standards.

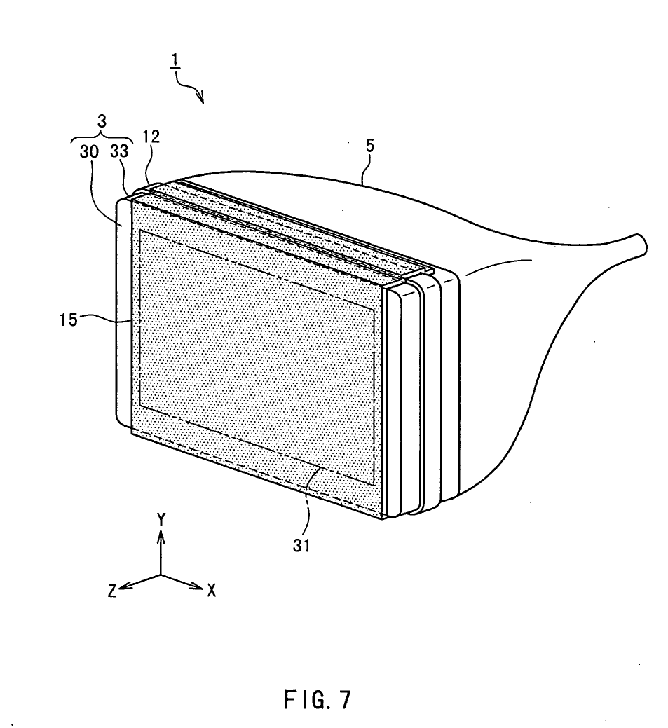

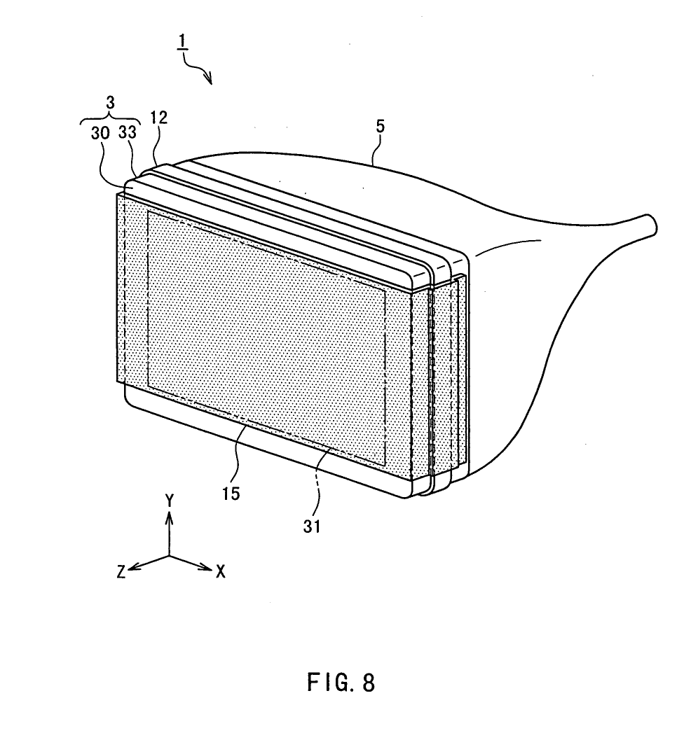

Also, in the case where the resin sheet 15 was attached to the panel 3 in such a manner as to extend from the useful portion 31 via both long sides of the faceplate 30 to at least a part of the portion of the metal band 12 parallel with the X axis as shown in FIG. 7 and in the case where the resin sheet 15 was attached to the panel 3 in such a manner as to extend from the useful portion 31 via both short sides of the faceplate 30 to at least a part of the portion of the metal band 12 parallel with the Y axis as shown in FIG. 8, it was confirmed that the thickness of the resin sheet 15 equal to or larger than 25 μm fully satisfied the various safety standards.

In a cathode ray tube whose useful portion had a dimension along its diagonal axis of 59 cm, an effect similar to the above was confirmed when using the panel 3 with Tc=9 mm, Tx=13.4 mm, Ty=19.1 mm, Td=22.3 mm and D=632.2 mm. In a cathode ray tube whose useful portion had a dimension along its diagonal axis of 68 cm, an effect similar to the above was confirmed when using the panel 3 with Tc=10.5 mm, Tx=16.9 mm, Ty=23.5 mm, Td=27.9 mm and D=724 mm. Further, when using the panel 3 whose useful portion 31 had an aspect ratio of 16:9, an effect similar to the above also was confirmed when Formulae (1) and (2) above were satisfied.

The present invention is utilized in any fields with no particular limitation and can be used for cathode ray tubes for various purposes. The present invention can be utilized particularly preferably for middle and large sized cathode ray tubes whose useful portion has a substantially flat outer surface and a dimension along its diagonal axis of at least about 41 cm.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A cathode ray tube comprising:
an envelope formed by connecting a glass funnel and a glass panel having a substantially rectangular useful portion whose outer surface is substantially flat;
wherein the cathode ray tube satisfies
0.8≦(100×Tc/D)²×(Tx/Ty)≦2.2, and (1)
0.012≦Tc/D≦0.019 (2)
where a Z axis indicates a tube axis, an X axis indicates an axis that is perpendicular to the Z axis and parallel with a long-side direction of the useful portion, a Y axis indicates an axis that is perpendicular to the Z axis and parallel with a short-side direction of the useful portion, Tx (mm) represents a thickness of the panel at a point of intersection of a plane including the X axis and the Z axis and an edge of the useful portion, Ty (mm) represents a thickness of the panel at a point of intersection of a plane including the Y axis and the Z axis and an edge of the useful portion, Tc (mm) represents a thickness of the panel at a center of the useful portion, and D (mm) represents an outer dimension of the panel along a diagonal axis direction.

2. The cathode ray tube according to claim 1, further comprising
a metal band placed on an outer peripheral surface of a skirt portion of the panel, and
a resin sheet attached so as to cover at least the outer surface of the useful portion,
wherein the cathode ray tube satisfies
0.012≦Tc/D≦0.016. (3)

3. The cathode ray tube according to claim 2, wherein the resin sheet has a thickness of equal to or larger than 50 μm.

4. The cathode ray tube according to claim 2, wherein the resin sheet has a thickness of equal to or larger than 25 μm, and the resin sheet is attached to the panel in such a manner as to extend from the useful portion to at least a part of a portion of the metal band parallel with the X axis.

5. The cathode ray tube according to claim 2, wherein the resin sheet has a thickness of equal to or larger than 25 μm, and the resin sheet is attached to the panel in such a manner as to extend from the useful portion to at least a part of a portion of the metal band parallel with the Y axis.

6. The cathode ray tube according to claim 1, wherein the useful portion has a dimension along its diagonal axis of at least about 41 cm.
